(19) United States
(12) Patent Application Publication
(10) Pub. No.: US 2008/0001469 A1
(43) Pub. Date: Jan. 3, 2008

(54) OIL LUBRICATED HUB

(76) Inventor: Charles H. DEEGEAR, Weatherford, TX (US)

Correspondence Address: HITCHCOCK EVERT LLP, P.O. BOX 131709, DALLAS, TX, 75313-1709, US

(21) Appl. No.: 11/428,179

(22) Filed: Jun. 30, 2006

(51) Int. Cl. B60B 27/00

(52) U.S. Cl. 301/108.1

(57) ABSTRACT

A hub assembly for oil lubricated hubs and a conversion kit to convert grease lubricated hubs to oil lubricated hubs. A hub assembly can include a hub defining a passageway that the axle spindle can pass through; the passageway also defines an inner bearing race, and an outer bearing race for receiving inner and outer bearings. The hub further defines an inner seating surface and an outer seating surface. The inner seating surface receives an inner seal and the outer seating surface can receive a cap or an extension and a cover. The extension and cover in a preferred embodiment serve many of the same purposes as a single cap. The cap has an axis and preferably defines a passageway along the same axis, and it has a wall member with a seating surface for engaging the seating surface of the hub. A stopper is provided in the passageway in the cap. In a preferred embodiment, an extension and cover is used in place of the cap. In a preferred embodiment, a removable stopper is placed in the passageway of the cover. For a conversion kit to convert grease lubricated hubs to oil lubricated hubs, only certain components need to be provided, and the hub and bearings of an existing unit are used.

### TECHNICAL FIELD OF THE INVENTION

The present invention relates to hubs for vehicles, such as trailers, and in particular components to convert a standard grease lubricated hub to an oil lubricated hub, as well as the design of an oil lubricated hub.

### BACKGROUND OF THE INVENTION

Many vehicles utilize axles having hub assemblies in which the bearings in the hub are packed with grease for lubrication. These hub assemblies are especially common on trailers such as boat, horse, stock, utility and specialty trailers. There are many trailers with grease lubricated hubs in use today. Grease lubricated hubs have several disadvantages. Boat trailers frequently are immersed in water to such an extent that the hubs assemblies are immersed in water. Many times the repeated immersion in water contributes to the failure of the bearings. Many trailers are used infrequently and are not maintained in a routine fashion like an automobile. In addition, the grease lubricated hub design does not permit for the easy inspection of the status of the grease, contributing to the lack of maintenance by the user. These factors contribute to the failure of grease lubricated bearings and associated hub. The grease can harden over the years and be lost from the bearings. A poorly lubricated bearing at high speeds can overheat to such an extent that bearing seizes. Thus, there has been a need for a hub design which provided excellent lubricating properties and also allowed for easy inspection and maintenance. Another advantage of oil lubricated bearings over grease lubricated bearings is that the speed at which the hub can be successfully operated is generally 20% or higher for oil lubricated bearings over grease lubricated bearings.

In view of the number of trailers in use today having greased bearings there is a need for a system to quickly and conveniently convert the commonly used standard hub assembly of the grease lubricated design to a new oil lubricated design. Thus, there was a need for a conversion kit which could be used in conjunction with existing standard hub assembly designs to convert them from grease lubrication to oil lubrication.

### SUMMARY OF THE INVENTION

The invention in one embodiment relates to a hub assembly useful for the lubrication of bearings with oil. A hub assembly can include a hub defining a passageway that the axle spindle can pass through; the passageway also defines an inner bearing race, and an outer bearing race for receiving inner and outer bearings. The hub further defines an inner seating surface and an outer seating surface. The inner seating surface receives an inner seal and the outer seating surface can receive a cap or an extension and a cover. The extension and cover in a preferred embodiment serve many of the same purposes as a single cap. The cap has an axis and preferably defines a passageway along the same axis; it has a wall member with a seating surface for engaging the seating surface of the hub. A stopper is provided in the passageway in the cap. In a preferred embodiment, an extension and cover is used in place of the cap. The extension has a seating surface for mating with the outer seating surface of the hub, and a connecting surface for connecting the cover to the extension. The cover has an axis and defines a passageway along the axis, and further defines a connecting surface for mating with the connecting surface of the extension to connect the cover to the extension. In a preferred embodiment, a removable stopper is placed in the passageway of the cover. In a preferred embodiment, an O ring seal is provided between the extension and the cover.

In another embodiment, the invention relates to a conversion kit for converting grease lubricated hub assembly to an oil lubricated hub assembly. Known grease lubricated hubs include a hub defining a passageway that an axle spindle can pass through; the passageway also defines an inner bearing race, and an outer bearing race for receiving inner and outer bearings. The hub further defines an inner seating surface and an outer seating surface. The inner seating surface receives an inner seal and the outer seating surface can receive a cap. In one embodiment, the conversion kit includes at least one extension having an axis and defining a seating surface for mating with the outer seating surface of the hub, and a connecting surface for connecting the cover to the extension. The kit also includes at least one cover which has an axis and defines a passageway along the axis, and further defines a connecting surface for mating with the connecting surface of the extension to connect the cover to the extension. In a preferred embodiment, the kit includes at least one removable stopper to be inserted in the passageway of the cover. In another embodiment, the kit includes at least one inner seal. In another embodiment, the kit also includes at least one O ring dimensioned to fit between the extension and the cover. In another embodiment, the kit includes a bottle of lubricating oil. Alternatively, the kit can be a cap having a passageway and a seating surface together with an inner seal if desired.

In yet another embodiment, the invention relates to a conversion kit for converting grease lubricated hub assembly to an oil lubricated hub assembly. Known grease lubricated hubs include a hub defining a passageway that the axle spindle can pass through; the passageway also defines an inner bearing race, and an outer bearing race for receiving inner and outer bearings. The hub further defines an inner seating surface and an outer seating surface. The inner seating surface receives an inner seal and the outer seating surface can receive a cap. The kit includes at least one cap having an axis and defines a passageway along the same axis, and a wall member with a seating surface for engaging the seating surface of the hub. The kit also includes at least one stopper which can be removably placed in the passageway in the cap. In another embodiment, the kit includes an inner seal and can include a bottle of lubricating oil.

In preferred embodiments, the inner seal is a three part seal having an axle engaging member, a hub engaging member, a ring to assist in holding of the axle engaging member and hub engaging member together in a sealing relationship, but which allows the axle engaging member and the hub engaging member to rotate with respect to one another.

### BRIEF DESCRIPTION OF THE DRAWINGS

A more complete understanding of the invention and its advantages will be apparent from the following detailed description when taken in conjunction with the accompanying drawings in which:

FIG. 1 is an exploded isometric view of an axle and hub assembly;

FIG. 1A is a side view of a spindle;

FIG. 2 is a cross sectional view of a hub;

FIG. 3 is a side view of one embodiment of a hub extension;

FIG. 3A is a cross sectional view of the hub extension of FIG. 3;

FIG. 4 is a top view of one embodiment of an outer cover;

FIG. 4A is a cross sectional view of FIG. 4;

FIG. 5 is a cross sectional view of one embodiment of an inner seal;

FIG. 6 is an exploded view of another embodiment of an inner seal;

FIG. 6A is a cross sectional view of an assembled inner seal shown in FIG. 6;

FIG. 7 is an exploded isometric view of an embodiment of a cap; and

FIG. 8 is an isometric view of a kit of the present invention.

### DETAILED DESCRIPTION

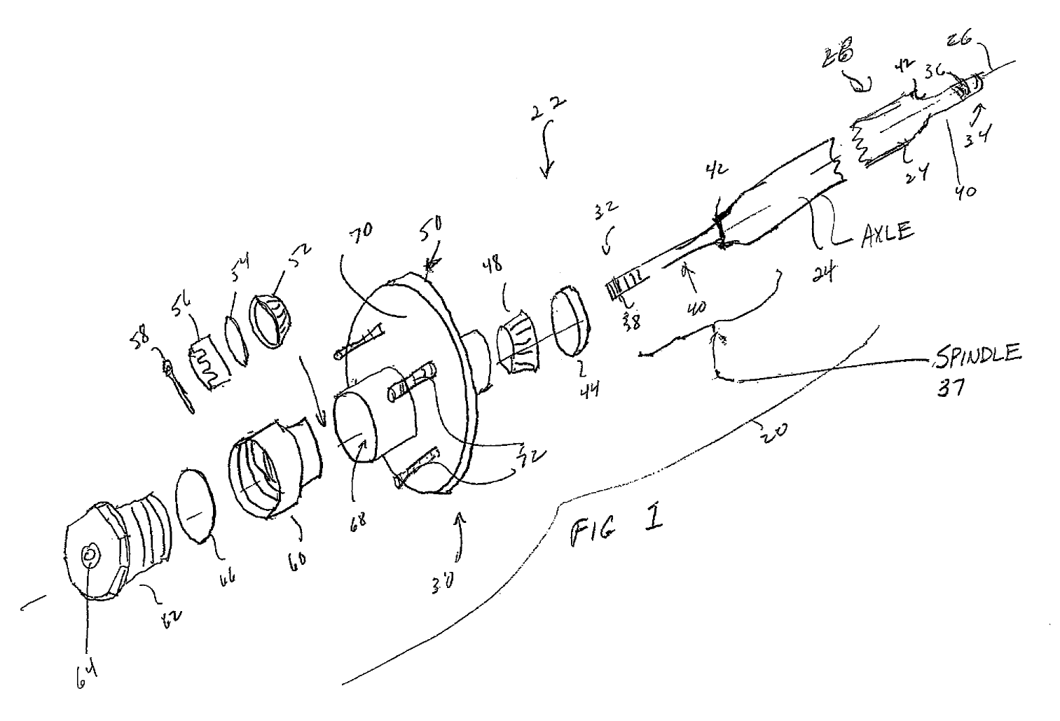

The same reference number when used in more that one figure refers to the same element. FIG. 1, shows one side 20 of an axle assembly 22 which has an axle 24 having an axis 26, it being understood that one side of an axle assembly 22 will normally be a mirror image of the other side. However, the two sides need not be complete mirror images as accessory items can be attached to one side but not to the other side. For simplification of description, the components on the other side 28 of the axle 24 are not shown, but it will be understood that mirror image components of the other components would be present. For purposes of discussion, various embodiments will be discussed but the limiting of the discussion to various particular embodiments should not be considered limiting of the nature of the invention. In addition, the fact that a limiting number of components of an axle assembly are discussed should not be taken to imply that other components, such as brakes and springs, can not also be included in the axle assembly.

In FIG. 1, a hub assembly 30 is illustrated in an exploded fashion. Hub assembly 30 is mounted on axle 24 forming part of axle assembly 22. Axle 24 defines an axis 26. The axle 24 has a first end 32 and a second end 34. In one embodiment, the outboard ends 36 of the axle includes spindles 37 having threaded ends, and a passageway 38 is provided at a predetermined location in the threaded outboard end portion 36. Spindle 37 is illustrated in detail in FIG. 1A. Spindle 37, in a preferred embodiment, includes inner bearing shoulder 42 located at a predetermined position to limit the movement of the hub assembly 30 in a direction towards the center to the axle 24. Inboard of inner bearing shoulder 42 is a inner sealing surface 43 on which inner seal 44 rests or is in sealing contact. Outboard of inner bearing shoulder 42 is inner bearing surface 45 on which the inner bearing runs. Outboard of the inner bearing surface 45 is outer bearing surface 46 on which the outer bearing runs.

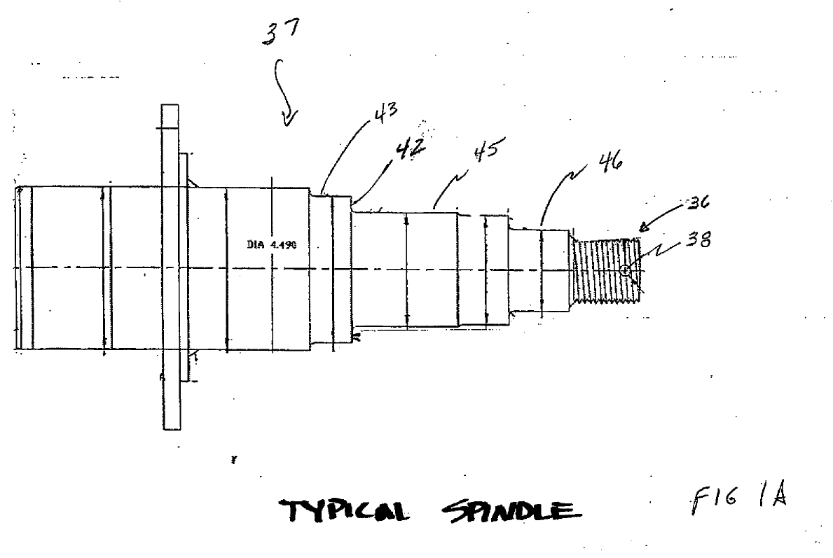

FIG. 1 illustrates one embodiment of a hub assembly 30. The hub assembly 30 includes an inner seal 44, an inner bearing 48, a hub member 50, an outer bearing 52, an outer washer 54, a nut 56 with one serrated side, a cotter pin 58, an outer hub extension 60, an outer cover 62, and stopper 64. In a preferred embodiment, the assembly includes an O ring 66. Various constructions of hub assemblies can be used in the present invention, and not all of the parts illustrated in this embodiment are needed to provide a useful assembly. The hub member 50 can be of any known design. Generally, the hub member 50 will define a passageway 68 having an axis 69 which is the same as the axle axis 26, with a plate portion shown on FIG. 2, 70 extending perpendicular to the axis. The passageway 68 can further define an inner bearing race (not shown in FIG. 1) and an outer bearing race (not shown not shown in FIG. 1) or can include bearing races made from separate pieces as illustrated in FIG. 2. Plate portion 70 can have lug bolts 72 extending from it for the attachment of a wheel or in the alternative, threaded holes 73 can be provided in plate portion 70 to receive lug studs.

The axle assembly is preferably assembled by inserting the inner bearing and inner seal in the hub, pushing the hub over the spindle, and then inserting the outer bearings and then adding on the other parts to complete the assembly.

Referring to FIG. 2 an exploded view of one embodiment of a hub 50 is illustrated. In known hubs 50 for most light capacity trailers, those having an axle capacity of 8,000 pounds or less, the outer end of passageway 68 has typically been provided with an outer seating surface 74 to receive a grease cap (not shown) which was press fit into the hub to keep dirt and debris from the bearings which rest on outer bearing race 76 and inner bearing race 78. A outer cover stop 79 may be provided which limits the travel of the cover into the hub 50. Outer bearing race stop 81 can be provided to limit the travel of outer bearing race 76. The inner bearing race 78 rests against inner bearing race stop 83. Inboard of the inner bearing race is inner seating surface 80. Preferably an inner seal stop 87 is provided to limit travel of the inner seal into the hub 50. As explained above, a great number of light weight trailers using grease packed bearings and share the common design feature of the outer seating surface 74 for the cap. Also, as explained above, grease packed bearings have a number of disadvantages. When the hub assembly is mounted on the spindle, the inner seal 44 is pushed over the spindle shoulder and forms a seal with the spindle and forms a seal with the inside of the hub passageway. The inner bearing travel towards the center of the axle is limited by the spindle shoulder. The outer bearing is retained by the outer washer 54, if used, which is placed against the outside edge of the outer bearing, and the nut 56 is tightened to a predetermined amount which allows the hub assembly to rotate without binding or excessive wobble. To prevent the nut 56 from rotating loose a cotter pin 58 can inserted through passageway 38 and bent to prevent movement of nut 56. Thereafter, the hub extension 60 and cover 62 can be attached. Oil can be inserted into the hub assembly through the passageway in the outer cover 62 and stopper 64 is inserted into the passageway to prevent oil from flowing out of the hub assembly and to keep dirt, water and debris out of the hub assembly.

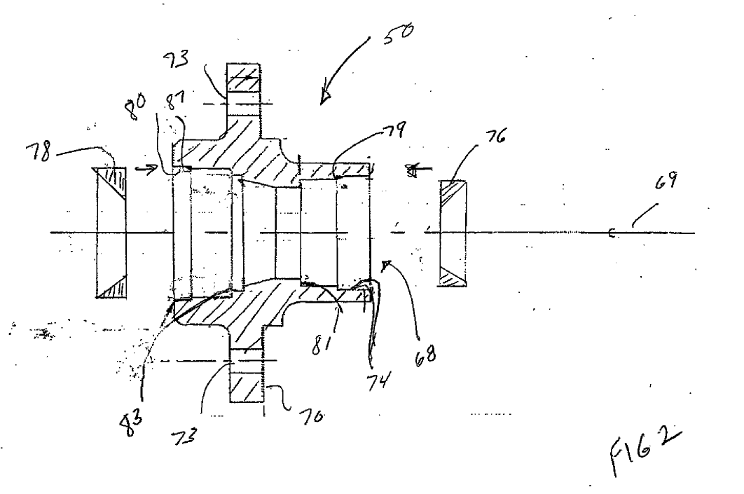

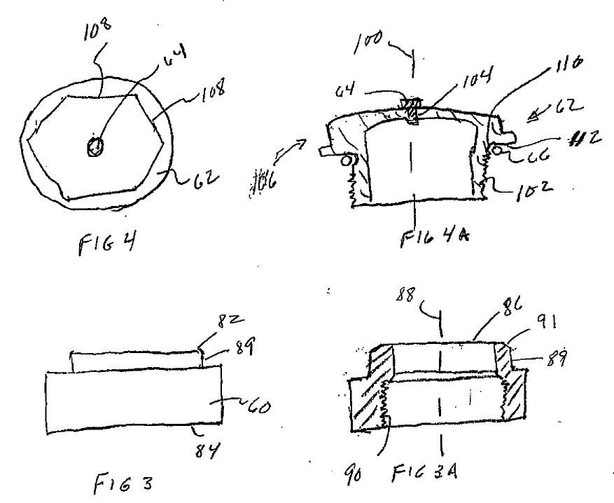

In one embodiment, the present invention relates to a kit for converting a grease lubricated hub assembly to an oil lubricated hub assembly 30. In this regard, in one embodiment a hub extension 60 is provided. As illustrated in FIGS. 3 and 3A, hub extension 60 has a first end 82 and second end 84 and defines a passageway 86 having an axis 88. In a preferred embodiment, the first end 82 has mating surface 89 for mating with outer seating surface 74 of the hub. In a preferred embodiment, the mating surface can be provided with a chamfer 85 on the first end 82 to assist in aligning and press fitting the mating surface into contact with the seating surface of the hub. The second end 84 of the hub extension 60 has a connecting surface 90, and in a preferred embodiment, the connecting surface is a threaded portion on the inside wall of the hub extension 60. While the connecting surface is illustrated in the preferred embodiment as a threaded inner wall, other connecting surfaces can be used such as threaded surface on the outside of the hub extension 60, or a press fit section. As shown in FIGS. 4 and 4A, in a preferred embodiment, the kit includes cover 62, which has an axis 100 and defines a connecting surface 102 dimensioned to be received by connecting surface 90 of the hub extension 60. In the illustrated embodiment, the connecting surface 102 of the cover 62 is a threaded surface on the external wall. Cover 62 also preferably defines a passageway 104. Passageway 104 receives a stopper 64. In a preferred embodiment, the first end 106 has two or more flat faces 108 to provide surfaces to cooperate with a tool for screwing the cover into the hub extension 60. In a preferred embodiment, the cover defines a groove 110 and a lip 112 at the end of the connecting surface 102. The groove 10 is dimensioned to receive O ring 66 and the lip to limit the travel of the cover into hub extension and to provide a sealing surface for the O ring.

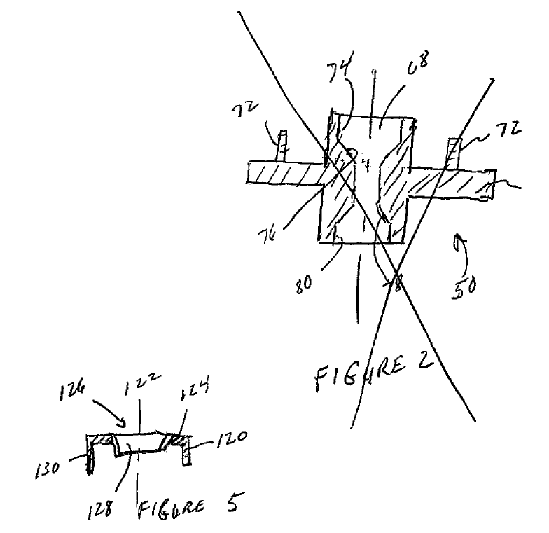

The inner end of the hub assembly 30 has an inner seal 44. Inner seal 44 can be of any design which will reliably retain lubricating oil in the hub. FIG. 5 illustrates one seal design of an inner seal which has a main member 120 which defines an axis 122. The first end 124 of the main member 120 is annular in shape with a passageway 126 through it. Attached adjacent to the passageway 126 is a flexible sealing member 128 which preferably extends toward the interior of the hub. The main member 120 also has a seating surface 130 extending from the first end 124. This surface is dimensioned to be received by the press fitting into inner seating surface 80 of hub member 50. Main member 120 can be made of metal and the flexible seal can be made of natural or synthetic rubber, or of flexible oil resistant polymer material. This type of inner seal is less desirable than the seal described below, because leaks may develop if the press fitting of the seal into the hub is not performed carefully, and the wear of the flexible seal as it rotates around the axle spindle 37.

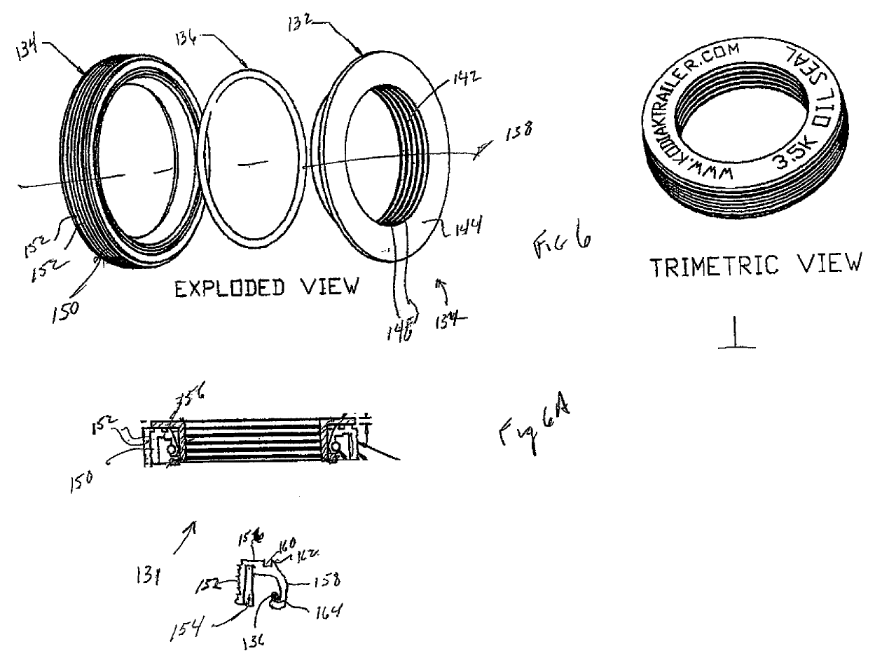

FIGS. 6 and 6A illustrate a preferred embodiment of an inner seal for use in the hub assembly. The inner seal 131 has three pieces, axle engaging member 132, hub engaging member 134, and ring 136. Axle engaging member 132 defines an axis 138 and has a wall member 140 which has a first portion 142 extending along axis 138, and a second portion 144 extending perpendicular to the axis 138. In a preferred embodiment, the axle engaging member has one or more ridges 146 made of resilient material extending inwardly. These ridges engage the axle and provide one or more seals with the axle; preferably at least three ridges are provided. The hub engaging member 134 has a “J” or “U” shaped cross section and defines an axis. The outer wall 150 extends generally parallel to the axis, and preferably has one or more resilient ridges 152 to provide for sealing with the hub inner seating surface 80. Preferably, three or more resilient ridges 152 are provided. Outer wall 150 is preferably has a rigid wall 154 covered by a resilient material having ridges 152 extending outwardly. The resilient material preferably then forms a first flexible wall portion 156 extending generally perpendicular to the axis, and a second flexible wall portion 158 extending generally parallel to the axis. The outside of the first flexible wall portion 156 in one embodiment is provided with a groove 160, and on one side of the groove 160, a wiper blade extension 162 is provided. At the end of the second flexible wall portion 158 opposite the first flexible wall portion 156, a channel 164 is provided on the interior of the second flexible wall member 158. Channel 164 receives ring 136. Ring 136 is preferably a spring and can be a coiled spring or flat spring. The purpose of the ring 136 is to hold the second flexible wall portion 158 in contact with the axle engaging member 132. This construction provides an inner seal in which a portion of the seal does not move with respect to the axle and a portion of the seal does not move with respect to the hub. The axle engaging member 132 and the hub engaging member 134 rotate with respect to one another in a manner that provides more reliable seal.

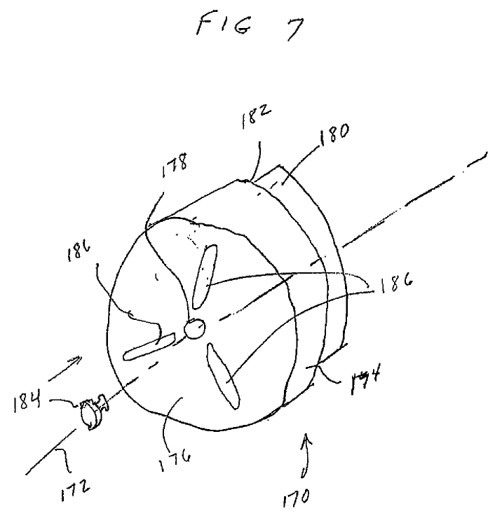

In another embodiment, the hub extension and the cover are combined in a single piece. As illustrated in FIG. 7, the extension cap 170 defines an axis 172 and has a wall member 174 extending generally parallel to the axis 172 and cap wall member 176 extending generally perpendicular to the axis 172 and defining a passageway 178 along the axis. In a preferred embodiment, the wall member 174 has a seating surface 180 for mating with a seating surface 74 in the hub 50 and a lip 182 to limit the travel of the extension cap 170 into the hub member 50. The passageway 178 is closed by a resilient stopper 184 in one embodiment. In a preferred embodiment, the extension cap is made of metal, and one or more sight glasses 186 are provided and preferably three or more sight glasses 186 are provided. The sight glass 186 can be made of any suitable material such as glass or transparent plastic. The use of three or more sight glasses 186 is useful because no matter the orientation of the wheel in a stopped position, one or more of the sight glasses 186 can be oriented such that visual inspection of the oil level would be possible. Alternatively, the cap can be made of plastic, and when made of plastic it is preferably made of a clear or translucent plastic so that sight glasses are not needed to view the oil level in the hub assembly. The two piece construction as illustrated in, for example FIG. 1, is considered preferable because it allows the cover to be removed and the oil drained from the hub. Thus, the lubrication oil can easily be changed.

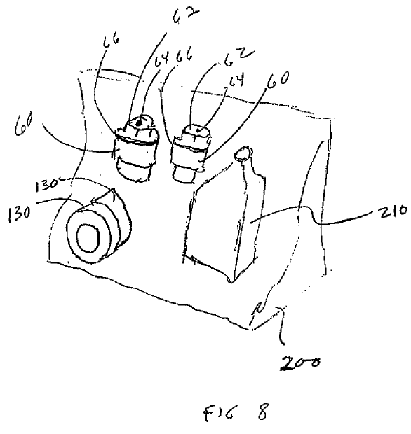

In a preferred use, a kit 200, such as illustrated in FIG. 8, is provided for the conversion of a grease pack hub to an oil lubricated hub. In one embodiment, the kit includes two hub extensions 60, two covers 62, two stoppers 64, two O ring seals 66 and two inner bearing seals 130. The kit can also include bearing oil 210 for the convenience of the customer. This kit allows for the conversion of an axle hub to oil lubrication. In operation, the user disassembles the grease lubricated hub assembly, replaces the inner seal with the inner seals provided with the kit, drives the hub extensions into each hub and then screws on the cover. After screwing on the cover, the stopper can be removed, and oil injected through the passageway in the cover until it reaches the bottom of the passageway and the stopper replaced. In a preferred embodiment, the cover 62 is made of transparent or translucent material such as a plastic. This aids in the proper maintenance of the hub assembly. The user can readily check the level and condition of the lubricating oil by a simple visual inspection. Thus, if the oil level is not sufficient, the user can readily detect the deficiency, remove the stopper and add additional oil. In the event the water has entered the hub, it can be detected by visual inspection. If water is detected in the bearing, the user can then take appropriate corrective action. Kits can also be provided for repair of a single hub assembly, having one hub extension, one inner seal and one cover. This allows the user with a kit to repair an axle which has been previously converted.

The seating surfaces have been described as machined surfaces which are suitable for press fitting parts together. However, the seating surfaces can also be threaded surfaces, or other surfaces that aid in the attachment of one piece to another. The hub, hub extension and cap can be made of metal, and are preferably made of metal. The cover is preferably made of a transparent or translucent plastic to allow visual inspection of the oil level. The stopper is preferably made from a resilient polymeric material resistant to oil. The passageways in the cap and the cover are provided so that oil can be inserted into the hub assembly. Thus, the passageways are of sufficient size to allow oil to be injected in the hub assembly. It is preferable that the diameter of the passageway not be more than about 0.5 inches. This is useful because the oil should be added in sufficient volume to cover the bearings up to a level close to the axis of the bearing. Thus, the bottom on the passageway can be used as an indicator of the proper fill level. The user can fill the hub assembly with oil to the level of the bottom of the passageway and then no additional oil can be added because it will drain out of the passageway. This prevents overfilling the hub assembly with oil.

Trailer axle assemblies are normally classified by weight capacities, and the size of axles and hubs vary accordingly. Accordingly, kits can be provided with conversion parts dimensioned for use in axles of the various weight capacities. Many variations of the various embodiments discussed above will be apparent to those skilled in the art without departing from the invention.

We claim:

1. A hub conversion kit having component parts capable of being assembled with an existing hub assembly having a hub member which has an inner seating surface and an outer seating surface comprising:
at least one hub extension defining a passageway and having a mating surface dimensioned to mate with said outer seating surface and having a connecting surface; and
at least one cover having a connecting surface to mate with said connecting surface of said hub extension.

2. A kit of claim 1 wherein said cover defines a passageway about the axis.

3. A kit of claim 2 further comprising at least one stopper dimensioned to fit in said passageway of said cover.

4. A kit of claim 3 further comprising at least one O ring dimensioned to fit between said cover and said extension.

5. A kit of claim 1 further comprising at least one inner seal dimensioned to mate with said inner seating surface of said hub.

6. A kit of claim 5 wherein said cover defines a passageway about the axis.

7. A kit of claim 6 further comprising at least one stopper dimensioned to fit in said passageway of said cover.

8. A kit of claim 7 further comprising at least one O ring dimensioned to fit between said cover and said extension.

9. A kit of claim 1 further comprising a bottle of lubricating oil.

10. A hub conversion kit having component parts capable of being assembled with an existing hub assembly having a hub member having an inner seating surface and a seating surface comprising:
at least one extension cap having an axis, and having a mating surface dimensioned to mate with said seating surface, and defining a passageway about said axis; and
at least one stopper.

11. A kit of claim 10 further comprising at least one sight glass in said extension cap.

12. A hub assembly comprising:
a hub member defining a passageway and an axis, said hub having an inner seating surface, and inner bearing race, an outer seating surface an outer bearing race seal;
an inner bearing positioned adjacent said inner bearing race;
an inner seal positioned adjacent said inner seating surface;
an outer bearing positioned adjacent said outer bearing race;
a cap attached to said outer seating surface and said cap having an axis and defining a passageway having a common axis; and
a stopper positioned in said passageway of said cap.

13. A hub assembly of claim 12 further comprising one or more sight glasses in said cap.
